(19) United States
(12) Patent Application Publication
(10) Pub. No.: US 2011/0249925 A1
(43) Pub. Date: Oct. 13, 2011

(54) BEARING ASSEMBLY

(76) Inventors: James Ching Sik LAU, Hong Kong (CN); Chun Kit Cheung, Hong Kong (CN)

(21) Appl. No.: 13/085,114

(22) Filed: Apr. 12, 2011

(30) Foreign Application Priority Data
Apr. 13, 2010 (CN) 201010150853.5

(51) Int. Cl. F16C 17/00

(52) U.S. Cl. 384/416

(57) ABSTRACT

A bearing assembly includes a shaft, a pair of spacers fixed on the shaft, and a bearing part surrounding and slidably contacting the spacers with a reservoir formed between the shaft, the spacers and the bearing part. The bearing part and spacers are made of hard material, such as a ceramic material.

### CROSS REFERENCE TO RELATED APPLICATIONS

This non-provisional patent application claims priority under 35 U.S.C. §119(a) from Patent Application No. 201010150853.5 filed in The People's Republic of China on Apr. 13, 2010.

### FIELD OF THE INVENTION

The invention relates to a bearing assembly, and in particular to a bearing assembly using hard materials such as ceramic materials.

### BACKGROUND OF THE INVENTION

A traditional shaft-bearing structure comprises a shaft and a sleeve bearing (also known as a bushing) rotatably supporting the shaft. The shaft is usually made of metal and the sleeve bearing made of a sintered metal such a bronze and is impregnated with oil. Such bushings have a disadvantage of oil leakage and short life. Bushings made of ceramic materials have been tried to overcome the oil leakage and to extend the life of the bushing. However, although the ceramic material is hard and has a greater resistance to abrasion, unfortunately the ceramic material causes significant wear of the shaft and the life of the shaft-bearing interface is not sufficiently increased.

Therefore, there is a need for an improved bearing structure which can solve the above-mentioned problems.

### SUMMARY OF THE INVENTION

Accordingly, the present invention provides a bearing assembly comprising: a shaft; a bearing support; and a bearing disposed between the shaft and the bearing support for rotatably connecting the shaft to the bearing support, wherein the bearing comprises a spacer and a bearing part slidably engaging the spacer, wherein the spacer and the bearing part are made of hard material.

Preferably, the hard material is a ceramic material.

Preferably, the spacer and/or the bearing part contains a solid lubricant.

Preferably, wherein the solid lubricant is Mo or MoS₂.

Preferably, there are two spacers axially spaced by a gap forming a lubricant reservoir.

Preferably, the spacers are fixed to the shaft and the bearing part is fixed to the bearing support.

Preferably, the spacers are an interference fit on the shaft.

Preferably, the shaft has a knurled portion and the spacers are press fitted to the knurled portion of the shaft.

Alternatively, the spacers are fixed to the shaft by elastic rings or by adhesive.

Preferably, the or each spacer comprises a connecting portion and a locating flange, the connecting portions forming a bearing surface engaging the bearing part and the locating flanges axially locate the bearing part on the bearing surface.

Preferably, the bearing support is part of a housing of an electric motor.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 illustrates a bearing assembly in accordance with a first embodiment of the present invention;

FIG. 2 illustrates a shaft and a spacer of the bearing assembly of FIG. 1;

FIG. 3 illustrates a shaft and a spacer of a bearing assembly in accordance with a second embodiment of the present invention; and

FIG. 4 illustrates a shaft and a spacer of a bearing assembly in accordance with a third embodiment of the present invention.

### DETAILED DESCRIPTION OF THE PREFERRED EMBODIMENTS

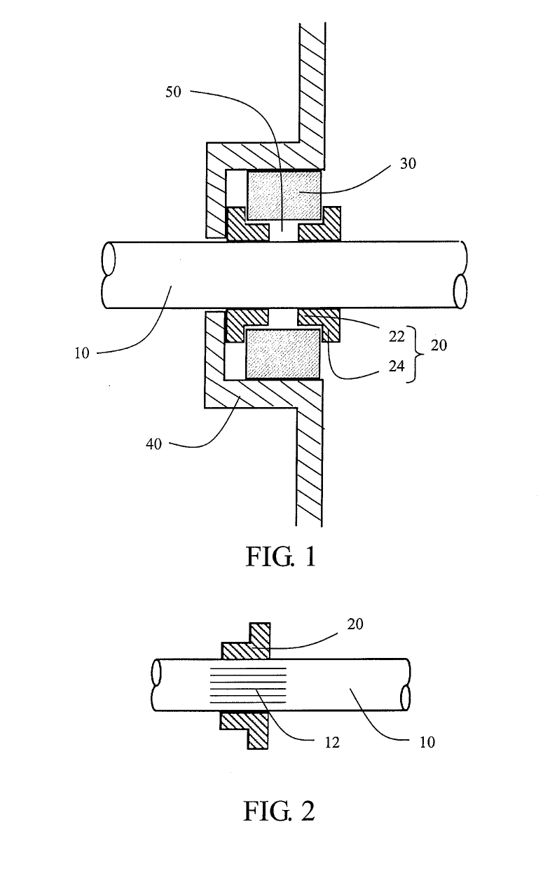

FIG. 1 illustrates a bearing assembly in accordance with a preferred embodiment of the present invention. The bearing assembly comprises a shaft 10, two spacers 20 fixedly attached on the shaft 10, and a bearing part 30 fixedly attached inside of a bearing support 40 such as a motor housing or bearing bracket. The shaft 10 extends through the bearing support 40.

Each spacer 20 comprises a connecting portion 22 and a locating flange 24 which has an outer diameter greater than that of the connecting portion 22. The two spacers 20 are spaced from each other with the connecting portions 22 facing each other across a small gap. The bearing part 30 is located between the locating flanges 24 and surrounds and slidably contacts with the connecting portions 22 of the spacers 20. Thus the two connecting portions 22 form a bearing surface for the bearing part 30. A reservoir 50 for lubricant is formed in the gap between the spacers and bounded by the outer surface of the shaft 10, end surfaces of the connecting portions 22 of the spacers 20 and the inner surface of the bearing part 30. The spacers 20 and the bearing part 30 are made of hard material, preferably a ceramic material. The material of the spacers and the bearing part may be different.

Preferably, the spacers 20 and/or the bearing part 30 are made of a ceramic material containing a solid lubricant. For example, the spacer 20 and/or bearing part 30 is made by sintering ceramic powder containing Mo or MoS₂ powder which becomes the solid lubricant.

In the above embodiment, as the spacers 20 are fixed on the shaft 10 while the bearing part 30 radially surrounds and slidably contacts with the spacers 20, the spacers protect the shaft from wear. The material of the spacers can be matched with the material of the bearing part 30 so that the wear of the rubbing surfaces can be tailored to suit the application. For example, the material may be selected so that equal wear occurs on the spacers and the bearing part. Alternatively, the materials may be selected so that the major wear occurs on the bearing part. This is especially desirable for applications where the bearing part can be readily replaced to extend the life of the motor. It should be realized that there is a compromise between costs, ease of assembly and the life of the bearing assembly.

Alternatively, the bearing part 30 may be an oil impregnated sleeve bearing and the reservoir 50 is arranged to store oil emitted or leaking from the bearing part 30.

In the present invention, the spacers 20 may be fixed to the shaft 10 in a variety of ways. For example, the spacers 20 may be fixed to the shaft 10 as an interference fit, being fitted by a thermal expansion method. Alternatively, a plurality of knurls in the form of axially extending ribs 12 may be formed on the outer surface of a portion of the shaft 10 and the spacers 20 are press fitted onto the portion of the shaft 10 where the ribs 12 are formed, as shown in FIG. 2.

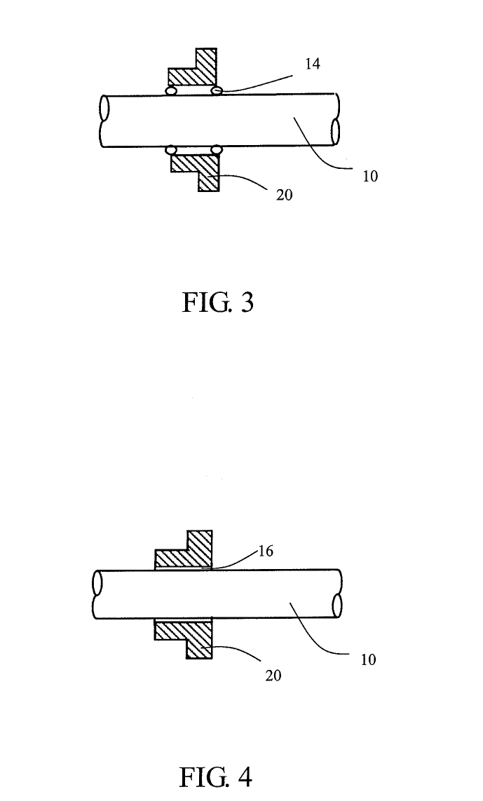

Alternatively, as shown in FIG. 3, elastic rings 14 are sandwiched between the spacers 20 and the shaft 10, whereby the spacers 20 are firmly fixed on the shaft 10.

Alternatively, adhesive 16 may be provided between the spacers 20 and the shaft 10, as shown in FIG. 4.

The term ‘hard material’ is meant to signify a material which has a hardness which is greater than the hardness of the shaft with which the bearing is to be or is being used. Preferably, the spacers and the bearing part have a similar hardness.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

1. A bearing assembly comprising:
a shaft;
a bearing support; and
a bearing disposed between the shaft and the bearing support for rotatably connecting the shaft to the bearing support,
wherein the bearing comprises a spacer and a bearing part slidably engaging the spacer, wherein the spacer and the bearing part are made of hard material.

2. The bearing assembly of claim 1, wherein the hard material is a ceramic material.

3. The bearing assembly of claim 1, wherein the spacer and/or the bearing part contains a solid lubricant.

4. The bearing assembly of claim 3, wherein the solid lubricant is Mo or MoS₂.

5. The bearing assembly of claim 1, wherein the spacer comprises a connecting portion and a locating flange, the connecting portion forming a bearing surface engaging the bearing part and the locating flange axially locates the bearing part on the bearing surface.

6. The bearing assembly of claim 1, wherein there are two spacers axially spaced by a gap forming a lubricant reservoir.

7. The bearing assembly of claim 6, wherein the spacers are fixed to the shaft and the bearing part is fixed to the bearing support.

8. The bearing assembly of claim 7, wherein the spacers are an interference fit on the shaft.

9. The bearing assembly of claim 7, wherein the shaft has a knurled portion and the spacers are press fitted to the knurled portion of the shaft.

10. The bearing assembly of claim 7, wherein the spacers are fixed to the shaft by elastic rings.

11. The bearing assembly of claim 7, wherein the spacers are fixed to the shaft by adhesive.

12. The bearing assembly of claim 6, wherein each spacer comprises a connecting portion and a locating flange, the connecting portions forming a bearing surface engaging the bearing part and the locating flanges axially locate the bearing part on the bearing surface.

13. The bearing assembly of claim 12, wherein the spacers are fixed to the shaft and the bearing part is fixed to the bearing support, the bearing part radially surrounding the spacers.

14. The bearing assembly of claim 1, wherein the bearing support is part of a housing of an electric motor.
